(19) United States
(12) Patent Application Publication
(10) Pub. No.: US 2012/0289255 A1
(43) Pub. Date: Nov. 15, 2012

(54) Selective Communication for Digital Coupon Distribution

(76) Inventor: Timothy Robards, Evansville, IN (US)

(21) Appl. No.: 13/467,488

(22) Filed: May 9, 2012

Related U.S. Application Data
(60) Provisional application No. 61/518,643, filed on May 9, 2011.

(51) Int. Cl. G06F 7/00; H04W 4/02; G06F 17/30; G06Q 30/02

(52) U.S. Cl. 455/456.3; 705/14.39; 707/610; 707/E17.032; 707/E17.018

(57) ABSTRACT

A proprietary website is maintained on which merchants can access their account, in order to add, delete, and amend digital coupons available. Consumers can download a mobile application to their mobile device and geographical co-ordinates selectively receive digital discount coupons displayed on the consumers mobile device when the consumer physically approaches or enters the participating merchant's place of business.

### CROSS REFERENCES TO RELATED APPLICATIONS

U.S. Provisional Application for Patent No. 61/518,643, filed May 9, 2011, with title “Selective Communication for Digital Coupon Distribution” which is hereby incorporated by reference. Applicant claim priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates to Internet electronic commerce and more particularly, to a method and system for selectively communicating, promoting, distributing, and redeeming digital coupons.

2. Brief Description of Prior Art.

Billions of consumers regularly use product redemption coupons and realize substantial savings as a result. Coupons are commonly used to encourage potential customers to purchase products as well as to encourage repeat customer transactions. With the growth of the World Wide Web as well as e-commerce, more consumers are utilizing internet resources when purchasing items. Moreover, with the growing popularity of various mobile devices, a user no longer needs to be sitting in front of his personal computer in order to access the internet. As a result, with today's advances in technology, a user with a mobile device can connect from most any location to the internet and to a host computer in order, for example, to receive and view available digital coupons. In light of these technological advances, an advantageous system would permit maximum flexibility with regard to when and where a coupon is available to a user and issued by a merchant. Further, it would be advantageous to provide maximum flexibility and convenience to users redeeming such coupons by avoiding limitations on when, where and how such coupons may be redeemed.

Thus, there remains a need to provide a method and system for digital coupon distribution on the World Wide Web. As will be seen from the subsequent description, the preferred embodiments of the present invention overcome these and other shortcomings of the prior art.

### SUMMARY OF THE INVENTION

The present invention is directed towards a technology by which a digital discount coupon issued by a merchant is only selectively delivered to a relevant consumer. In particular, the merchant's digital coupon to selectively deliver is obtained/delivered when the consumer is very near or entering that participating merchant's place of business.

A proprietary website is maintained on which merchants can access their account, in order to add, delete, and amend digital coupons available. Likewise, consumers can subscribe to the service in order to have digital discount coupons selectively delivered to the consumers mobile device. Once subscribed, participating consumers can receive digital coupons for each participating merchant when the consumer physically approaches or enters the participating merchant's place of business.

Essentially, any portable device having communication capability may act as a consumer device. Non-limiting examples of consumer devices include a mobile phone or a personal computer (which may be a tablet, handheld, or palm-sized device, and so forth). One or more other devices such as a personal digital assistant, or a Smartphone, and so forth may also act as consumer devices.

It should be noted that the technology described herein is independent of any particular form of delivery, content and/or how the consumer receives the information, e.g. visually by text, graphics and/or video, or by listening to audible content. As such, any means of communication may be used, and any visible and/or audible feedback may be used to selectively communicate information. Thus, as used herein “coupon” or “digital coupon” or “electronic coupon” is not limited to any particular form, format or the like.

Coupons are “clipped” by the consumer scrolling through the delivered advertisements and selecting the desired coupon. The consumer is then able to effect a real-time application of the “clipped” coupon selectively delivered to the consumer's device. In particular, the coupons disclosed and available are used in the normal fashion by a consumer when shopping at a participating merchant. That is, the coupons are presented to a product or service check-out station along with the associated products or services for purchase, and the discount available with the coupon(s) is credited to the consumer at the point of sale.

### BRIEF DESCRIPTION OF THE DRAWINGS

FIG. 1 is a block diagram schematic of the method and system of the preferred embodiment for selectively communicating and delivering digital coupons, to targeted recipients on-line.

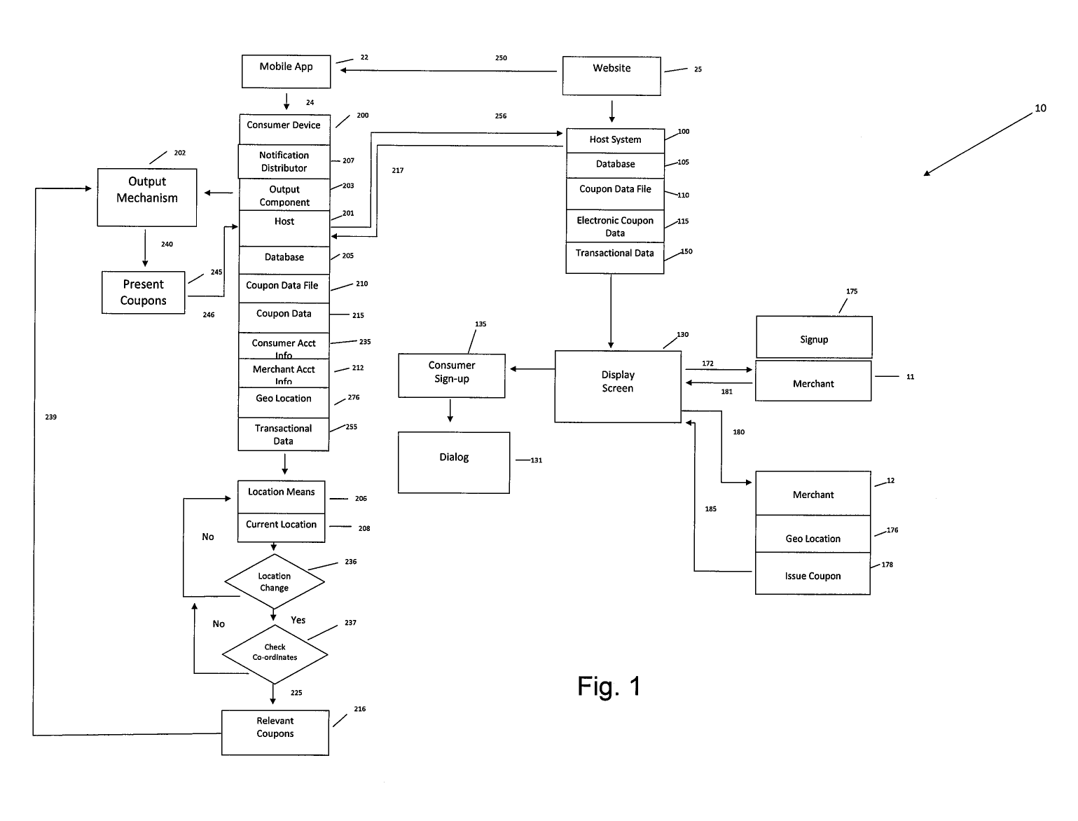

### DESCRIPTION OF THE PREFERRED EMBODIMENT

In accordance with the present invention, a method and system for selectively delivering digital coupons to one or more targeted recipients, referred to as consumers, generally based upon the consumer's location is disclosed. More particularly, the described method relates to a centrally located online computer system for interactively distributing coupons to consumers remotely connected. Specifically, it will be noted in the following description that the present method discloses an efficient method of selectively distributing money saving, digital discount coupons online. In the broadest context, the method and system disclosed consists of components and steps configured with respect to each other so as to attain the desired objective.

### Host System

Referring to the drawings, the method designated as numeral 10 for digital coupon distribution is disclosed. The digital coupon distribution system 10 of the present invention comprises a central located repository of electrically stored data, which in the preferred embodiment includes an online service provider or host system 100.

It is within the scope of this invention that a consumer uses a portable device, preferably a mobile phone, to selectively receive relevant coupon information based upon the location of the consumer's device. The host system 100 includes a computer-accessible data base 105 with relevant files that include available coupon(s) and other information as will be discussed. The host system 100 can be accessible in any known way including, but not limited to, by phone, by cable, and by wireless systems. It is within the scope of this invention for the host system 100 to be an accessible stand-alone computer system; an internet service provider that provides access to the internet; or any known computerized network. As such, the online service provider 100 herein refers to any computer-based information service provider which is accessible by a remote personal computer or mobile device that is readily accessible to the internet.

The host system 100 (and any system disclosed herein) has well known means for accomplishing each of its functions, including, but not limited to, means for storing digitized information; means for mathematical calculations; means for transmitting and/or receiving data and/or digitized information; and means for report generating.

In general, the computer-accessible database 105 includes a coupon data file 110 that stores electronic coupon data 115 and other types of advertising materials and information supplied by participating merchants. Relevant coupons 216, as will be described, are displayed on the participating consumer's device 200 based upon the physical location of the consumer's device. Advertisements 115 in the coupon data file 110 may consist of graphics, texts, competitions or other inducements or a combination thereof. However, it should be noted that the technology described herein is independent of any particular form of delivery, content and/or how the consumer receives the information, e.g. visually by text, graphics and/or video, or by listening to audible content. As such, any means of communication may be used, and any visible and/or audible feedback may be used to selectively communicate information.

The coupon data file 110 of the preferred embodiment comprises of coupon data 115 which is entered by the participating merchant (as will be described), and represents specific coupons electronically “clipped” and stored therein. The functional aspects of the host system provider 100 in the preferred embodiment include the entry and organization of coupons 115 in the coupon data file 110, the data statistics file that maintains transactional data, and the online communications server.

The host system 100 has stored in its database 105 various records of electronic coupon data 115, the content of which will be further described below. The host system 100 can also store in its database 105 user-specific information, including the number of consumers that visit selected merchant locations, buying habits of participating consumers, and so forth.

The coupons 115 disclosed and available in the present invention are used in the normal fashion by a consumer when shopping at a participating merchant. That is, the digital coupons are presented to a product or service checkout station along with the associated products or service for purchase, and the discount available with the coupon is credited to the consumer at the point of sale.

A potential consumer using the personal computer (or mobile device 200) connects to the host system 100 through the system's proprietary website 25. An online display screen 130 includes a “Consumer Signup” 135. When a consumer elects to initially register with the digital coupon distribution service, the consumer selects the “Consumer Signup” 135 which initiates a dialog 131 in order to request certain information in order to create an account for the consumer.

The online display screen 130 further includes a “Merchant Signup” 175 and a “Merchant Login” 180. A merchant 11 who desires to participate in the present system and have its coupons 115 delivered to participating consumers via the host system 100 as described, sets up an account 172 with the host system by selecting the “Merchant Signup” 175.

When a merchant desires to initially register for the digital coupon distribution service, the merchant selects the “Merchant Signup” 175 which initiates a dialog with the host system 100 in order to request certain information in order to create the account 172 for that participating merchant 12. In addition the dialog requests the geographical location 176 of the participating merchant's 12 place of business. A participating merchant 12 is assigned a unique account number and password for accessing the host system 100 to provide information, coupons, change and add information, etc.

Once the merchant account information is provided and the system has created 181 the merchant's account 172 and assigned to the merchant the account number and password, thereafter, the participating merchant 12 can access the merchant's account 172 by selecting the “Merchant Login” 180.

When a participating merchant 12 accesses its merchant's account 172, the merchant 12 has the ability to create a coupon, delete a coupon, or edit an existing coupon 178. To create a new coupon for that merchant, the merchant selects “create” which initiates a dialog with the host system 100 in order to request certain information or download information related to the merchant's new coupon to issue. Once the information is provided by the merchant and transmitted 185 to the host system 100, the system, utilizing the information provided by the merchant 12, causes the e-coupon 115 to be created in the form of a standardized computer file format. This file format may include, for example, a coupon title, a coupon description, a coupon code, an expiration date, any disclaimers, a graphic image, a bar code, a benefit definition and a product information data set. The benefit definition identifies the specific benefit to be accorded to a consumer when the computer file is redeemed. The benefit can consist of, for example, a discount relative to a purchase price, a credit applicable to the purchase price of a product, or a special offer. The special offer may be any type of special benefit to a consumer such as a premium offer, a multiple unit discount offer, and so on.

### Consumer Device

For purposes herein, a “consumer device” can essentially be any portable device having communication capabilities. Non-limiting examples of consumer devices include a mobile phone or a personal computer (which may be a tablet, hand-held, palm-sized device, and so forth). One or more other devices such as a personal digital assistant, Smartphone, and so forth may also act as consumer's devices. In the preferred embodiment, the consumer's device 200 is a mobile phone.

The digital coupon distribution system 10 includes a mobile application 22 that is downloadable 24 to the participating consumer's device 200. The consumer device 200, for purposes herein, has the mobile application 22 download.

Each consumer device 200 participating in the present system has access to the internet; note that in alternative implementations, a private network service may be used, but for purposes of description herein, the internet will be used as an example of communication means. Consumer access may be via the cellular system, via wireless internet connectivity, by satellite, or by any other practical means of connecting a device to the internet. The means of connecting is immaterial, although as is understood some sort of connectivity is needed to enable device participation.

Also required is a notification distributor 207 for sending electronic information to consumers, e.g., via the public instant messaging system or the like. As should be understood, an example implementation comprises a consumer-side output component 203 at each consumer device 200. The output component 203 generally comprises a program or other logic suitable for running on that type of consumer device 200. In general, the output component 203 is coupled to an output mechanism 202 such as a display and/or speaker for outputting delivered relevant coupons 216 on the consumer device 200. In general, when the consumer's device 200 is near or is entering a participating merchant's 12 place of business, the output component 203 receives relevant coupon displays 216 entered in the coupon data file 210 for that merchant 12, and instantly communicates such received data to the output mechanism 202 of the consumer device 200.

The consumer device 200 of the distribution system 10 includes a host system 201 and a second database 205 which as will be described is preferably a mirror image of the computer accessible database 105 where the database 205 is regularly updated to mirror the database 105. Preferably, the database 205 is updated as described, every 5-10 minutes. As will be understood, the database 205 interface with the downloadable application 22 such that relevant coupon information 116 delivered from the database 105 to database 205 on the device 200 is delivered and displayed on the device 200 directly from the second database 205.

The host system 201 has well known means for accomplishing each of its functions including, but not limited to, means for storing digitized information; means for mathematical calculations; means for transmitting and/or receiving data and/or digitized information. The functional aspects of the device's host system 201 in the preferred embodiment include the filtering, retrieval and displaying of relevant coupons 216, means for transmitting and/or receiving data, and means to accumulate and transfer transactional data to the data statistics file on the database 105.

As understood, the database 205 includes a coupon data file 210 that comprises of coupon data 215 which is received from the records of electronic coupon data 115 delivered by the database 105. As previously described, the coupons 215 disclosed and available are used in the normal fashion by a consumer when shopping at a participating merchant. That is, the coupons are presented to a product for service checkout station along with the associated products or service for purchase, and the discount available with the coupon is credited to the consumer at the point of sale.

The database 205 further includes consumer account information 235 as entered 135 during the “consumer sign-up” process earlier described. The database 205 further includes the merchant account information 212 as entered 175 during the “merchant sign-up” process earlier described, including merchant's geo location 276 information as entered for the participating merchant 12 during the “merchant sign-up” process. Again, it is critical that the database 205 on the consumer device 200 is updated 217 with the information earlier entered into the database 105 by the consumer and merchant, and that the database 205 be updated 217 regularly in order to reflect any additions, deletions or amendments made by the consumer or merchant.

Another critical feature is directed towards the consumer's device 200 including location means 206 to periodically check the device's 200 current location 208, and in which filtering of coupons 225 for selective delivery 239 is performed by the system database 205 of the present system. As can be readily appreciated, the consumer device 200 location 208 can be determined 206 without consumer intervention, such as by cellular phone triangulation and geo-locator, proximity detection, and so forth.

The location means 206 continuously evaluates 236 whether the consumer's location has changed. Note that there may be some threshold amount of change before it is considered sufficient movement to update. Note that this also correlates with update frequency. There may be a limit placed on how frequently the location means evaluates whether the consumer's state or location has changed, e.g. once every three, five, or ten minutes for example. Note that the desired frequency can be configured by the consumer.

If a location change is detected, the data is reported to the host system 201, e.g., via the above exemplified location means described. Note that if no change of location is detected, a timer or the like may be used before the next location evaluation.

When a consumer location change is detected, the system 201 determines 237 whether there is any relevant data information to be sent to the consumer's device 200, e.g., whether the consumer device's current location 208 co-ordinates is the same or near the location 176 co-ordinates of any of the participating merchants 12. When the co-ordinates 208, 176 are the same or near the same, the coupons 216 for that merchant 12 in the coupon data file 210 are delivered 239 to the output mechanism (display) 202 of the consumer device 200 and the notification 207 is activated to notify the user that relevant coupons 216 for that participating merchant 12 are available.

According to the system and method of the present invention, a consumer engages in a purchasing activity at the participating merchant's place of business with the merchant's issued coupon. As discussed, the proprietary website 25 is maintained for participating merchants to access their accounts, in order to add, delete, and amend coupons available on that site. Likewise, consumers can have selectively delivered information and coupons for each participating merchant as they physically approach or enter the participating merchant's place of business, i.e., when the device's current geographic co-ordinates is the same or near the geographic co-ordinates of a participating retail merchant. Note that the information displayed on the consumer's device is received directly from the app database 205. Note also that the service tracks the location(s) 208 of the consumer's registered device, and not the actual consumer. As a result more than one of the consumer's devices may be in motion at the same time. This raises no technical problems for the service implementation, and as a side note, allows tracking of a lost or stolen device.

When selecting 240 a coupon 216, the consumer is able to select a coupon 216 displayed on the consumer's device 200 and is able to effect a real-time application of the rebate/discount advertised and delivered by that specific merchant 12. That is, the selected relevant coupons 216, as displayed on the device 200, are presented to a product or service check-out station 245 along with the associated products or services for purchase, and the discount available with the coupon 216 is credited to the consumer at the point of sale.

The present invention also includes an electronic note delivery service 250 that provides selective note delivering to participating consumers. Such note delivering aspect could be via email or text messaging. The note delivering service anticipated herein, may send notes that inform the consumer of things that are potentially interesting to them on the basis of where they are located, the time, and/or their personal contacts.

The system's database 105 includes the accumulation of relevant information 150 for each participating consumer that includes at the very least, identity information and information relevant to the selected consumer's device. The relevant information 150 further includes transactional information 255 received 256 from the consumer's device database 205, that maintains 246 records of each coupon-related transaction completed with the system.

As should now be understood, relevant advertising may be delivered to any consumer who meets the location criteria. This means that electronic coupons are delivered to a consumer's device as the consumer approaches a business, e.g., a restaurant at lunch time, an oil change facility when an oil change is due, a current price list from upcoming gasoline stations, and so forth. Thus, by tracking locations of registered consumers, delivery of a targeted coupon such as audio or an electronically displayed message may be selectively made to that user.

Although the description above contains many specificities, these should not be construed as limiting the scope of the invention but as merely providing illustrations of some of the presently preferred embodiments of this invention. Thus the scope of the invention should be determined by the appended claims in the formal application and their legal equivalents, rather than by the examples given.

I claim:

1. A data distribution system comprising:
a first host system having a first database that stores electronic data, said first database including a merchant file containing merchant name data, a merchant location file containing merchant location data, and a merchant content file containing merchant content data;
a consumer device having a second host system and an output means, said second host system including a second database including a merchant name file, a merchant location file, and a merchant content file;
means for copying said electronic data from said first database to said second database;
said consumer device further including location means to identify the consumer device's current location;
wherein said output means sends an alert when said device's current location is approximately equal to the merchant location data contained in the second database.

2. The data distribution system as recited in claim 1, further including means for performing a transaction from said consumer device when said alert is sent.

3. The data distribution system as recited in claim 1, wherein said system further includes means for updating said first database.

4. The data distribution system as recited in claim 2, further including means for storing said transaction on said first database.

5. The data distribution system as recited in claim 4, wherein said merchant location data in said first database is geographic co-ordinates, and wherein said device's current location is geographic co-ordinates.

6. An online method for digital content distribution comprising:
storing on a host system available content information from participating merchants;
storing on said host system geo-data for each participating merchant;
determining if a merchant is a participating merchant, and if the merchant is not said participating merchant:
i) creating a dialog with the merchant in order for the merchant to complete a merchant application and transmit a completed merchant application to the host system,
ii) receiving and storing the completed merchant application at the host system,
iii) assigning a unique account number and password to the merchant for accessing the host system; and wherein
if the merchant is said participating merchant, accessing the stored participating merchant's content information to create a content, delete a content, or edit an existing content issued by that participating merchant and transmitting to the host system;
storing said issued content and said participating merchant's geo-data on a first database;
periodically copying said first database to a second database, wherein said second database is a downloadable mobile application to a user's mobile device such that the user receives relevant issued content by said participating merchant from the second database on the user's mobile device when the user's mobile device current location is near the geo-location of said participating merchant's;
selecting said relevant issued content from the user's mobile device;
scanning information relating to the selected content.

7. The method as recited in claim 6, wherein said content is a digital coupon.

8. An online system for digital content distribution comprising:
a first database storing content information from participating merchants, wherein said first database further storing geo-data for each said participating merchant;
copying means for periodically copying said content information and geo-data from said first database to a second database, wherein said second database is a downloaded mobile application to a user's mobile device;
wherein said mobile device includes location means to identify the mobile device's current location;
wherein said mobile device further includes output means that sends an alert when said mobile device's current location is approximately equal to said participating merchant's geo location data stored in said second database;
wherein said mobile device displays said content information by said participating merchant when said current location is approximately equal to said merchant's geo location;
selecting means based upon said content information displayed on said mobile device.

9. The online system as recited in claim 8, further including means for performing a transaction when said alert is sent.

10. The online system as recited in claim 9, further including means for storing said transaction on said first database.

11. The online system as recited in claim 8, wherein said online system further includes means for updating said first database.

12. The online system as recited in claim 8, wherein said merchant geo location in said first database is geographic co-ordinates, and said mobile device's current location is geographical co-ordinates.
